(19) United States
(12) Patent Application Publication
(10) Pub. No.: US 2015/0162602 A1
(43) Pub. Date: Jun. 11, 2015

(54) NANOCOMPOSITE COATINGS TO OBTAIN HIGH PERFORMING SILICON ANODES

(71) Applicant: GM Global Technology Operations LLC, Detroit, MI (US)

(72) Inventors: Gayatri Vyas Dadheech, Bloomfield Hills, MI (US); Nicholas P. W. Pieczonka, Windsor (CA); Michael P. Balogh, Novi, MI (US)

(73) Assignee: GM Global Technology Operations LLC, Detroit, MI (US)

(21) Appl. No.: 14/102,216

(22) Filed: Dec. 10, 2013

(51) Int. Cl. H01M 4/36; H01M 4/04; H01M 4/38; H01M 4/583; H01M 4/48

(52) U.S. Cl. CPC H01M 4/366; H01M 4/583; H01M 4/48; H01M 4/386; H01M 4/0423; H01M 4/0428; H01M 10/052

(57) ABSTRACT

An electrode material for use in an electrochemical cell, like a lithium ion battery, is provided. The electrode material may be a negative electrode comprising silicon. A nanocomposite surface coating comprising carbon and metal oxide comprising a metal selected from a group consisting of: titanium (Ti), aluminum (Al), tin (Sn), and combinations thereof is particularly useful with negative silicon-based electrodes to minimize or prevent charge capacity loss in the electrochemical cell. The coating may be ultra-thin with a thickness of less than or equal to about 60 nm. Methods for making such materials and using such coatings to minimize charge capacity fade in lithium ion electrochemical cells are likewise provided.

### FIELD

The present disclosure relates to high performance silicon-containing electrodes for lithium ion electrochemical devices, where the silicon-containing electrodes comprise a nanocomposite surface coating to prevent capacity fade and enhance long-term performance, methods for making such coatings on silicon-containing electrodes, and methods for use thereof.

### BACKGROUND

This section provides background information related to the present disclosure which is not necessarily prior art.

High-energy density, electrochemical cells, such as lithium ion batteries can be used in a variety of consumer products and vehicles, such as Hybrid Electric Vehicles (HEVs) and Electric Vehicles (EVs). Typical lithium ion batteries comprise a first electrode (e.g., a cathode), a second electrode (e.g., an anode), an electrolyte material, and a separator. Often a stack of lithium ion battery cells are electrically connected to increase overall output. Conventional lithium ion batteries operate by reversibly passing lithium ions between the negative electrode and the positive electrode. A separator and an electrolyte are disposed between the negative and positive electrodes. The electrolyte is suitable for conducting lithium ions and may be in solid or liquid form. Lithium ions move from a cathode (positive electrode) to an anode (negative electrode) during charging of the battery, and in the opposite direction when discharging the battery.

Contact of the anode and cathode materials with the electrolyte can create an electrical potential between the electrodes. When electron current is generated in an external circuit between the electrodes, the potential is sustained by electrochemical reactions within the cells of the battery. Each of the negative and positive electrodes within a stack is connected to a current collector (typically a metal, such as copper for the anode and aluminum for the cathode). During battery usage, the current collectors associated with the two electrodes are connected by an external circuit that allows current generated by electrons to pass between the electrodes to compensate for transport of lithium ions.

Many different materials may be used to create components for a lithium ion battery. By way of non-limiting example, cathode materials for lithium batteries typically comprise an electroactive material which can be intercalated with lithium ions, such as lithium-transition metal oxides or mixed oxides of the spinel type, for example including spinel LiMn₂O₄, LiCoO₂, LiNiO₂, LiMn_{1.5}Ni_{0.5}O₄, LiNi_{(1-x-y)}CoₓM_{y}O₂ (where 0<x<1, y<1, and M may be Al, Mn, or the like), or lithium iron phosphates. The electrolyte typically contains one or more lithium salts, which may be dissolved and ionized in a non-aqueous solvent. The negative electrode typically includes a lithium insertion material or an alloy host material.

Typical electroactive materials for forming an anode include lithium-graphite intercalation compounds, lithium-silicon intercalation compounds, lithium-tin intercalation compounds, lithium alloys. While graphite compounds are most common, recently, anode materials with high specific capacity (in comparison with conventional graphite) are of growing interest. For example, silicon has the highest known theoretical charge capacity for lithium, making it one of the most promising materials for rechargeable lithium ion batteries. However, current anode materials comprising silicon suffer from significant drawbacks. The large volume changes (e.g., volume expansion/contraction) of silicon-containing materials during lithium insertion/extraction (e.g., intercalation and deintercalation) results in cracking of the anode, a decline of electrochemical cyclic performance and diminished Coulombic charge capacity (capacity fade), and extremely limited cycle life.

It would be desirable to develop high performance negative electrode materials comprising silicon for use in high power lithium ion batteries, which overcome the current shortcomings that prevent their widespread commercial use, especially in vehicle applications. For long term and effective use, anode materials containing silicon should be capable of minimal capacity fade and maximized charge capacity for long-term use in lithium ion batteries.

### SUMMARY

This section provides a general summary of the disclosure and is not a comprehensive disclosure of its full scope or all of its features.

In certain variations, the present disclosure provides an electrode for an electrochemical cell, such as a lithium ion battery. The electrode may be a negative anode. The electrode comprises silicon. The electrode further comprises a coating formed on one or more surface regions of the electrode. The coating may comprise carbon and a metal oxide comprising a metal selected from a group consisting of: titanium (Ti), aluminum (Al), tin (Sn), and combinations thereof.

In other variations, the present disclosure contemplates a lithium ion electrochemical cell. The electrochemical cell comprises a negative electrode comprising silicon. The negative electrode further has a surface coating formed on one or more surface regions thereof. The surface coating comprises carbon and a metal oxide comprising a metal selected from a group consisting of: titanium (Ti), aluminum (Al), tin (Sn), and combinations thereof. A positive electrode comprises a positive lithium-based electroactive material. The electrochemical cell also comprises a separator and an electrolyte. The surface coating on the negative electrode provides a Coulombic capacity loss of less than or equal to about 10% after 25 cycles of lithium ion intercalation and deintercalation in the negative electrode of the lithium ion electrochemical cell.

In yet other aspects, the present disclosure provides a method of making a negative electrode for an electrochemical cell. The method comprises applying a surface coating comprising carbon and a metal oxide comprising a metal selected from a group consisting of: titanium (Ti), aluminum (Al), tin (Sn), and combinations thereof to one or more surface regions of an electrode material comprising silicon. In certain aspects, the applied surface coating is ultra-thin having a thickness of less than or equal to about 100 nm, optionally less than or equal to about 90 nm, optionally less than or equal to about 80 nm, optionally less than or equal to about 70 nm, optionally less than or equal to about 60 nm, optionally less than or equal to about 50 nm, optionally less than or equal to about 40 nm, optionally less than or equal to about 30 nm, optionally less than or equal to about 20 nm, optionally less than or equal to about 10 nm, and in certain variations, optionally less than or equal to about 5 nm. In certain aspects, the applied surface coating is ultra-thin having a thickness of greater than or equal to about 3 nm and less than or equal to about 100 nm.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an exemplary electrochemical battery cell;

FIGS. 2A and 2B are scanning/transmission electron microscope (s/TEM) images. FIG. 2A is an image of a carbon fiber electrode having a silicon coating and FIG. 2B is the silicon coated carbon fiber electrode having an additional surface coating comprising titanium dioxide (TiO₂);

FIG. 3 shows specific capacity of a lithium ion battery having a silicon-containing anode material with a crystallized TiO₂ coating over 5 cycles of charging and discharging;

FIG. 4 shows specific capacity of a lithium ion battery having a silicon-containing anode material with an amorphous TiO₂ coating over 7 cycles of charging and discharging;

FIG. 5 shows comparative specific capacities of lithium ion batteries having comparative silicon-containing carbon nanofiber anode materials over 30 cycles of charging and discharging;

FIG. 6 is a s/TEM image of a nanomat carbon electrode material having a silicon coating further having a nanocomposite surface coating of carbon and TiO₂ according to certain variations of the present disclosure; and

FIG. 7 shows normalized discharge capacity of a lithium ion battery having a silicon-containing anode material having a nanocomposite surface coating of carbon and TiO₂ according to certain variations of the present disclosure over 50 cycles of charging and discharging.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range, including endpoints given for the ranges.

As used herein, the terms “composition” and “material” are used interchangeably to refer broadly to a substance containing at least the preferred chemical compound, but which may also comprise additional substances or compounds, including impurities.

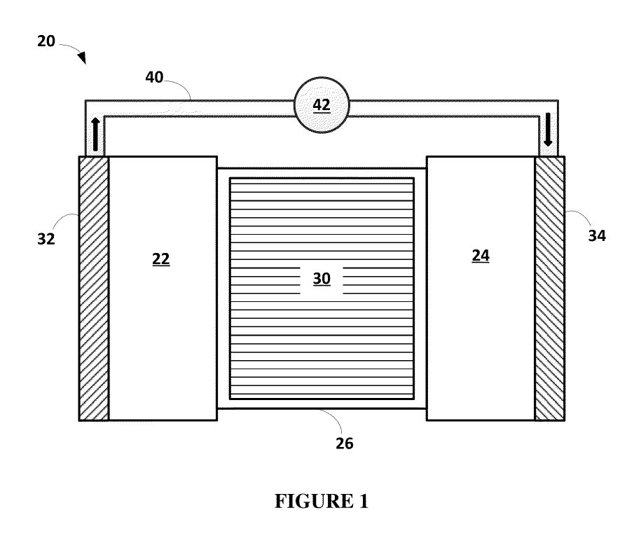

The present technology pertains to improved electrochemical cells, especially lithium ion batteries, which may be used in vehicle applications. An exemplary and schematic illustration of a lithium ion battery 20 is shown in FIG. 1. Lithium ion battery 20 includes a negative electrode 22, a positive electrode 24, and a separator 30 (e.g., a microporous polymeric separator) disposed between the two electrodes 22, 24. The separator 26 comprises an electrolyte 30, which may also be present in the negative electrode 22 and positive electrode 24. A negative electrode current collector 32 may be positioned at or near the negative electrode 22 and a positive electrode current collector 34 may be positioned at or near the positive electrode 24. The negative electrode current collector 32 and positive electrode current collector 34 respectively collect and move free electrons to and from an external circuit 40. An interruptible external circuit 40 and load 42 connects the negative electrode 22 (through its current collector 32) and the positive electrode 24 (through its current collector 34). Each of the negative electrode 22, the positive electrode 24, and the separator 26 may further comprise the electrolyte 30 capable of conducting lithium ions. The separator 26 operates as both an electrical insulator and a mechanical support, by being sandwiched between the negative electrode 22 and the positive electrode 24 to prevent physical contact and thus, the occurrence of a short circuit. The separator 26, in addition to providing a physical barrier between the two electrodes 22, 24, can provide a minimal resistance path for internal passage of lithium ions (and related anions) for facilitating functioning of the lithium ion battery 20.

The lithium ion battery 20 can generate an electric current during discharge by way of reversible electrochemical reactions that occur when the external circuit 40 is closed (to connect the negative electrode 22 and the positive electrode 34) when the negative electrode 22 contains a relatively greater quantity of intercalated lithium. The chemical potential difference between the positive electrode 24 and the negative electrode 22 drives electrons produced by the oxidation of intercalated lithium at the negative electrode 22 through the external circuit 40 toward the positive electrode 24. Lithium ions, which are also produced at the negative electrode, are concurrently transferred through the electrolyte 30 and separator 26 towards the positive electrode 24. The electrons flow through the external circuit 40 and the lithium ions migrate across the separator 26 in the electrolyte 30 to form intercalated lithium at the positive electrode 24. The electric current passing through the external circuit 18 can be harnessed and directed through the load device 42 until the intercalated lithium in the negative electrode 22 is depleted and the capacity of the lithium ion battery 20 is diminished.

The lithium ion battery 20 can be charged or re-powered at any time by connecting an external power source to the lithium ion battery 20 to reverse the electrochemical reactions that occur during battery discharge. The connection of an external power source to the lithium ion battery 20 compels the otherwise non-spontaneous oxidation of intercalated lithium at the positive electrode 24 to produce electrons and lithium ions. The electrons, which flow back towards the negative electrode 22 through the external circuit 40, and the lithium ions, which are carried by the electrolyte 30 across the separator 26 back towards the negative electrode 22, reunite at the negative electrode 22 and replenish it with intercalated lithium for consumption during the next battery discharge cycle. The external power source that may be used to charge the lithium ion battery 20 may vary depending on the size, construction, and particular end-use of the lithium ion battery 20. Some notable and exemplary external power sources include, but are not limited to, an AC wall outlet and a motor vehicle alternator. In many lithium ion battery configurations, each of the negative current collector 32, negative electrode 22, the separator 26, positive electrode 24, and positive current collector 34 are prepared as relatively thin layers (for example, several microns or a millimeter or less in thickness) and assembled in layers connected in electrical parallel arrangement to provide a suitable energy package.

Furthermore, the lithium ion battery 20 can include a variety of other components that while not depicted here are nonetheless known to those of skill in the art. For instance, the lithium ion battery 20 may include a casing, gaskets, terminal caps, and any other conventional components or materials that may be situated within the battery 20, including between or around the negative electrode 22, the positive electrode 24, and/or the separator 26, by way of non-limiting example. As noted above, the size and shape of the lithium ion battery 20 may vary depending on the particular application for which it is designed. Battery-powered vehicles and hand-held consumer electronic devices, for example, are two examples where the lithium ion battery 20 would most likely be designed to different size, capacity, and power-output specifications. The lithium ion battery 20 may also be connected in series or parallel with other similar lithium ion cells or batteries to produce a greater voltage output and power density if it is required by the load device 42.

Accordingly, the lithium ion battery 20 can generate electric current to a load device 42 that can be operatively connected to the external circuit 40. The load device 42 may be powered fully or partially by the electric current passing through the external circuit 40 when the lithium ion battery 20 is discharging. While the load device 42 may be any number of known electrically-powered devices, a few specific examples of power-consuming load devices include an electric motor for a hybrid vehicle or an all-electrical vehicle, a laptop computer, a tablet computer, a cellular phone, and cordless power tools or appliances, by way of non-limiting example. The load device 42 may also be a power-generating apparatus that charges the lithium ion battery 20 for purposes of storing energy.

Any appropriate electrolyte 30, whether in solid form or solution, capable of conducting lithium ions between the negative electrode 22 and the positive electrode 24 may be used in the lithium ion battery 20. In certain aspects, the electrolyte solution may be a non-aqueous liquid electrolyte solution that includes a lithium salt dissolved in an organic solvent or a mixture of organic solvents. Numerous conventional non-aqueous liquid electrolyte 30 solutions may be employed in the lithium ion battery 20. A non-limiting list of lithium salts that may be dissolved in an organic solvent to form the non-aqueous liquid electrolyte solution include LiPF₆, LiClO₄, LiAlCl₄, LiI, LiBr, LiSCN, LiBF₄, LiB(C₆H₅)₄, LiAsF₆, LiCF₃SO₃, LiN(CF₃SO₂)₂, and combinations thereof. These and other similar lithium salts may be dissolved in a variety of organic solvents, including but not limited to various alkyl carbonates, such as cyclic carbonates (ethylene carbonate (EC), propylene carbonate (PC), butylene carbonate (BC)), acyclic carbonates (dimethyl carbonate (DMC), diethyl carbonate (DEC), ethylmethylcarbonate (EMC)), aliphatic carboxylic esters (methyl formate, methyl acetate, methyl propionate), γ-lactones (γ-butyrolactone, γ-valerolactone), chain structure ethers (1,2-dimethoxyethane, 1-2-diethoxyethane, ethoxymethoxyethane), cyclic ethers (tetrahydrofuran, 2-methyltetrahydrofuran), and mixtures thereof.

The separator 30 may comprise, in one embodiment, a microporous polymeric separator comprising a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP.

When the separator 30 is a microporous polymeric separator, it may be a single layer or a multi-layer laminate, which may be fabricated from either a dry or wet process. For example, in one embodiment, a single layer of the polyolefin may form the entire microporous polymer separator 30. In other aspects, the separator 30 may be a fibrous membrane having an abundance of pores extending between the opposing surfaces and may have a thickness of less than a millimeter, for example. As another example, however, multiple discrete layers of similar or dissimilar polyolefins may be assembled to form the microporous polymer separator 30. The microporous polymer separator 30 may also comprise other polymers in addition to the polyolefin such as, but not limited to, polyethylene terephthalate (PET), polyvinylidene fluoride (PVDF), and/or a polyamide. The polyolefin layer, and any other optional polymer layers, may further be included in the microporous polymer separator 30 as a fibrous layer to help provide the microporous polymer separator 30 with appropriate structural and porosity characteristics. Various conventionally available polymers and commercial products for forming the separator 30 are contemplated, as well as the many manufacturing methods that may be employed to produce such a microporous polymer separator 30.

The positive electrode 24 may be formed from a lithium-based active material that can sufficiently undergo lithium intercalation and deintercalation while functioning as the positive terminal of the lithium ion battery 20. The positive electrode 24 may include a polymeric binder material to structurally fortify the lithium-based active material. One exemplary common class of known materials that can be used to form the positive electrode 24 is layered lithium transitional metal oxides. For example, in certain embodiments, the positive electrode 24 may comprise at least one spinel comprising a transition metal like lithium manganese oxide (Li₍₁₊ₓ₎Mn₍₂₋ₓ₎O₄), where 0≦x≦1, where x is typically less than 0.15, including LiMn₂O₄, lithium manganese nickel oxide (LiMn₍₂₋ₓ₎NiₓO₄), where 0≦x≦1 (e.g., LiMn_{1.5}Ni_{0.5}O₄), lithium cobalt oxide (LiCoO₂), lithium manganese oxide (LiMn₂O₄), lithium nickel oxide (LiNiO₂), a lithium nickel manganese cobalt oxide (Li(NiₓMn_{y}Co_{z})O₂), where 0≦x≦1, 0≦y≦1, 0≦z≦1, and x+y+z=1, including LiMn_{0.33}Ni_{0.33}CO_{0.33}O₂, a lithium nickel cobalt metal oxide (LiNi_{(1-x-y)}CoₓM_{y}O₂), where 0<x<1, y<1, and M may be Al, Mn, or the like, other known lithium-transition metal oxides or mixed oxides lithium iron phosphates, or a lithium iron polyanion oxide such as lithium iron phosphate (LiFePO₄) or lithium iron fluorophosphate (Li₂FePO₄F). Such active materials may be intermingled with at least one polymeric binder, for example, by slurry casting active materials with such binders, like polyvinylidene fluoride (PVDF), ethylene propylene diene monomer (EPDM) rubber, or carboxymethoxyl cellulose (CMC). The positive current collector 34 may be formed from aluminum or any other appropriate electrically conductive material known to those of skill in the art.

In various aspects, the negative electrode 22 includes an electroactive material as a lithium host material capable of functioning as a negative terminal of a lithium ion battery. The negative electrode 22 may thus include the electroactive lithium host material and optionally another electrically conductive material, as well as one or more polymeric binder materials to structurally hold the lithium host material together. In accordance with various aspects of the present disclosure, the negative electrode 22 may include an active anode material comprising silicon. Thus, in certain variations, the anode active material may be in the form of particles that are intermingled with a material selected from the group consisting of: polyvinylidene difluoride (PVDF), a nitrile butadiene rubber (NBR), carboxymethoxyl cellulose (CMC), and combinations thereof, by way of non-limiting example, which form the negative electrode 22. The negative electrode current collector 32 may be formed from copper or any other appropriate electrically conductive material known to those of skill in the art.

As noted above, anode active materials comprising silicon have the highest known theoretical charge capacity for lithium, which makes them quite desirable for use in rechargeable lithium ion batteries. For example, Si-based electrodes have been considered for high-performance applications (EVs/HEVs) due to their high specific capacity and energy density materials. However, in practice, conventional anode materials comprising silicon suffer from significant drawbacks. Such silicon-containing materials show large volume changes (e.g., volume expansion/contraction) during lithium insertion/extraction (e.g., intercalation and deintercalation) resulting in cracking of the anode, a decline of electrochemical cyclic performance and diminished Coulombic charge capacity (capacity fade), and extremely limited cycle life. In particular, capacity fading for silicon-based anodes has been challenging and a barrier to their widespread use in lithium ion batteries.

Notably, the present technology is particularly suitable for use with negative electrode Si-based negative electrode (anode) materials for lithium ion batteries for the negative electrode 22 that comprise silicon materials. Thus, in accordance with certain aspects of the present disclosure, the negative electrode 22 is a material that comprises silicon. Such a material may be silicon (capable of intercalating lithium) or may be lithium-silicon and silicon containing binary and ternary alloys, such as Si—Sn, SiSnFe, SiSnAl, SiFeCo, and the like. In certain embodiments, the silicon containing material comprises or consists essentially of silicon (rather than alloys of silicon). In certain variations, the negative electrode active material comprises a particle or fiber having a coating of a material comprising silicon. In certain embodiments, the particle or fiber comprises carbon. Suitable carbon particles include carbon or graphite fibers, carbon black, graphene, and graphite, by way of non-limiting example. In certain alternative variations, the particle or fiber may comprise aluminum oxide or titanium oxide, which is then coated with a material comprising silicon.

In certain variations, the negative electrode comprises a fiber coated with the material comprising silicon, where the fiber is selected from a group consisting of: carbon fibers, alumina (Al₂O₃) fibers, titanium oxide (TiO₂) fibers. In other variations, the negative electrode comprises a carbon fiber coated with a material comprising silicon (e.g., silicon). In certain variations, a plurality of carbon fibers coated with a material comprising silicon can be in the form of a nano-mat.

In other alternative variations, the anode material may comprise silicon and be in the form of nanowires, nanorods, nanosprings, or hollow tubes. Such silicon structures can help accommodate the large volume changes that silicon undergoes during lithium cycling in a lithium ion battery. In certain variations, the silicon structure may further comprise a carbon material deposited thereon.

In various aspects, the inventive technology pertains to providing high performance, low capacity loss negative electrode materials comprising silicon. For example, the present disclosure contemplates an electrode material for an electrochemical cell comprising a coating formed on one or more surface regions of a negative electrode comprising a material comprising silicon. In certain aspects, the coating comprises an oxide of a metal selected from a group consisting of: titanium (Ti), aluminum (Al), tin (Sn), and combinations thereof. In certain preferred variations, the coating comprises both carbon and a metal oxide comprising a metal selected from a group consisting of: titanium (Ti), aluminum (Al), tin (Sn), and combinations thereof. The metal oxide is optionally selected from a group consisting of titanium oxide (e.g., TiO₂), aluminum oxide (e.g., Al₂O₃), tin oxide (e.g., SnO₂), and combinations thereof. It should be noted that the amount of oxygen may vary in the metal oxide coating, as desired, so that a titanium oxide may not necessarily be stoichiometrically titanium dioxide (TiO₂) and the like. In certain preferred variations, the surface coating comprises carbon and titanium oxide (e.g., TiO₂). Such a surface coating may be considered to form a nanocomposite of carbon and titanium oxide. A surface coating may include a plurality of layers of distinct material compositions (e.g., a first layer comprising carbon and a second layer comprising a metal oxide) or may include one or more layers of a material comprising both carbon and metal oxide combined together. The surface coating may thus comprise a plurality of distinct layers.

In certain aspects, the present disclosure contemplates atomic layer deposition (ALD) of the metal oxide and/or carbon material, which allows for a thin conformal coating to be formed on electrodes. Such a coating is demonstrated to moderate the mechanical degradation from volume expansion/contraction during Li-ion insertion/extraction. In certain variations, the coating has a thickness of less than or equal to about 100 nm, optionally less than or equal to about 90 nm, optionally less than or equal to about 80 nm, optionally less than or equal to about 70 nm, optionally less than or equal to about 60 nm, optionally less than or equal to about 50 nm, optionally less than or equal to about 40 nm, optionally less than or equal to about 30 nm, optionally less than or equal to about 20 nm, optionally less than or equal to about 10 nm, and in certain variations, optionally less than or equal to about 5 nm. In certain variations, the coating has a thickness of greater than or equal to about 3 nm to less than or equal to about 5 nm. In certain variations, a layer of carbon material is deposited over one or more surface regions on the silicon material. The carbon material may have a plurality of pores defined therein. The metal oxide layer may be deposited over the carbon. In certain aspects, the metal oxide layer is conformal and may fill a portion of or substantially all of the voids defined by the pores in the carbon material, so as to define a nanocomposite. The metal oxide and the carbon may be substantially evenly or homogenously distributed on the surface regions of the silicon-containing material. In such variations, a thickness of the porous carbon layer may be less than or equal to about 55 nm, while a thickness of the oxide of metal layer is less than or equal to about 5 nm. In certain other variations, the metal oxide and the carbon material may be co-deposited with one another to form a single layer on the surface of the silicon-containing material.

In accordance with the present teachings, surface coatings are used as an efficient way to resolve the problem of structural stress/strain in a silicon containing anode material during Li-ion insertion/extraction, by incorporating an elastic material (e.g., metal oxides) into the system that helps reduce mechanical stress, cracking, and/or fracture during lithium migration. Accordingly, silicon-based anodes treated in accordance with the principles of the present disclosure desirably have less than or equal to about 40% charge capacity decay, optionally less than or equal to about 30% capacity decay, optionally less than or equal to about 25% capacity decay, optionally less than or equal to about 20% capacity decay, optionally less than or equal to about 15% capacity decay and in certain high performing silicon-based anodes, capacity decay is less than or equal to about 10%. Hence, in certain variations, the present disclosure provides new surface coatings for anodes comprising silicon that can obtain high, in certain performing silicon-based anodes having less than or equal to about 10% of capacity decay, as will be described in greater detail below. For example embodiments, an anode comprising a silicon material has one or more surface regions coated with a surface coating that comprises carbon and titanium oxide (e.g., TiO₂) nanocomposite structures, which retain up to about 90% of charge capacity on silicon-coated carbon nanofibers electrode materials (such as nanomats). Thus, with the inventive composite surface coating, silicon-based anodes have a capacity retention up to about 90%.

A surface coating (such as an ALD deposited coating) in accordance with certain aspects of the present technology formed over the entire exposed surface of the electrode can also serve as an artificial solid electrolyte interface layer, which protects the electrode from reaction with liquid electrolyte. Many Li-ion batteries can suffer from capacity fade attributable to many factors, including the formation of passive film known as solid electrolyte interface (SEI) layer over the surface of the negative electrode (anode), which is often generated by reaction products of anode material, electrolyte reduction, and/or lithium ion reduction. The SEI layer formation plays a significant role in determining electrode behavior and properties including cycle life, irreversible capacity loss, high current efficiency, and high rate capabilities, particularly advantageous for power battery and start-stop battery use. In various aspects, the surface coating desirably has certain advantages, like high cut voltage (e.g., cut-off potentials relative to a lithium metal reference potential) that desirably minimizes or avoids SEI formation, and furthermore provides a low strain material having minimal volumetric change during lithium insertion and deinsertion, thus enabling long term cycling stability, high current efficiency, and high rate capabilities. Such long term cycling stability, high current efficiency, and high rate capabilities are particularly advantageous for power battery and start-stop battery use.

The nanocomposite surface coating according to certain aspects of the present disclosure is especially well-suited to minimizing or preventing mechanical stress and fracturing of negative electrodes comprising silicon and thus for enhancing capacity retention and reducing charge capacity decay to the levels described previously above. In various aspects, a surface coating is applied to one or more surface regions of an electrode material comprising silicon by a deposition process. In certain aspects, the process for applying the surface coating may be selected from a group consisting of atomic layer deposition (ALD), chemical vapor infiltration, chemical vapor deposition, physical vapor deposition, wet chemistry, and any combinations thereof. Indeed, in certain aspects, a deposition process may first comprise applying a carbon material to one or more surfaces of the electrode material by a first process, followed by applying a metal oxide material in a second process, so that the layers together define a nanocomposite surface coating. In certain aspects, the first and second processes may be in the same type of process or equipment, but the deposition or applying steps are carried out separately (e.g., sequentially). In other aspects, the first and second processes may be entirely distinct. In other aspects, a deposition process may comprise co-depositing or co-applying a carbon material and a metal oxide material to one or more surfaces of the electrode material by the same process to form the surface coating.

In certain variations, the carbon can be applied as a surface coating on the electrode material (e.g., material comprising silicon) by chemical vapor deposition (CVD), chemical vapor infiltration, physical vapor deposition (PVD), electron beam evaporation, laser arc evaporation, and other known conventional processes to apply such coatings to solid materials. For example, in a plasma CVD process or other thermal process, a thin layer of carbon can be deposited onto the surface of the electrode material by thermal decomposition of hydrocarbon compounds. Other processes may also be used, such as a PVD process like magnetron sputtering or via laser arc evaporation or electron beam evaporation. In certain aspects, a carbon coating may have an ultra-thin thickness as described above. For example, a carbon coating may have a thickness of greater than or equal to about 5 nm to less than or equal to about 60 nm. The deposition process may be done at temperatures ranging from room temperature (about 21° C.) to less than or equal to about 40° C. Carbon coatings obtained from such processes may be amorphous in nature and mainly comprise graphite-like carbon. For example, the carbon coating may have 20 to 30% hard carbon in it.

In certain aspects, the metal oxide portion of the surface coating may be applied by an atomic layer deposition (ALD) process that can coat the electrode material, such as silicon, with a conformal layer that comprises the metal oxide layer, such as titanium oxide (TiO₂). In certain aspects, the surface of the electrode to be coated by metal oxide may already have a carbon layer deposited thereon. As will be described below, in other aspects, both carbon and TiO₂ may be co-deposited in a process, such as ALD. ALD is a self-limiting process for chemical deposition or growth of ultra-thin films on a substrate. The ALD chemical gas-phase thin film deposition method is advantageous mainly for the surface-controlled and self-saturating monolayer formation, which can create new conformal structures for lithium ion battery electrodes. ALD typically involves subjecting the target substrate to self-saturating surface reactions. The surface reactions may be conducted sequentially and/or in an alternating fashion, depending on the composition and structure of the film desired. Typically, each precursor completely saturates the substrate thus forming a monolayer of material. Notably, oxygen ratios in a metal oxide may vary depending on deposition conditions. ALD process yields electrodes with gradually thicker coatings of the reaction product.

For a titanium oxide coating (TiO₂), the precursor materials may be titanium tetrachloride (TiCl₄), tetrakis(diethylamido)titanium(IV), tetrakis(dimethylamido)titanium(IV), and/or titanium(IV) isopropoxide, by way of example. Suitable non-limiting precursors for forming a titanium oxide coating via ALD comprise titanium tetrachloride (TiCl₄) and water (H₂O). For an aluminum oxide (Al₂O₃) coating, a precursor selected from the group consisting of: trimethyl aluminum (TMA ((CH₃)₃Al)), aluminum fluoride (AlF₃), aluminum nitride ((AlN) where the precursor is TMA and ammonia), and the like. For a tin oxide (e.g., SnO₂) coating, the ALD precursor materials may be SnCl₄, SnI₄, Bis[bis(trimethyl silyl)amino]tin (II), Dibutyldiphenyl tin, Hexaphenyl ditin(IV) tetra-allyl tin, tetravinyl tin, trimethyl(phenyl)tin, tin acetylacetonate, or heterocyclic tin with hydrogen peroxide, ozone or water.

ALD is typically conducted in an apparatus having a vacuum deposition chamber with a holder for the substrate, at least one vapor source (known as the precursor) and various controls by which the substrate may be individually subjected to the vapor source. Such controls may include heaters, coolers, flow routing and valves, for controlling the amount of exposure of the substrate to the vapor source. The regions of the electrode material to be coated may be pre-treated, for example, by plasma treatment. The ALD process for deposition of surface coating onto regions of the electrode material involves reaction of the surface in a deposition chamber with a single vapor of precursor materials or reaction of the surface with multiple vapors introduced sequentially and having the precursors of the surface coating. Suitable precursors may include organic and inorganic metallic compounds. The vapor may be pulsed into the vacuum deposition chamber on a carrier gas and may be quickly purged, for example, by vacuum pumping or flushing with an inert gas. Such pulsing of the vapor and purging of the system may be performed to control the dose of the precursor vapor to which the substrate is exposed.

Generally, the ALD process is performed at elevated temperatures and reduced pressures. Temperature of the deposition chamber is desirably high enough that reaction between the substrate and the precursors in the vapor occurs, while also preventing condensation of the vapor onto the surface. As non-limiting examples, the reaction space in the deposition chamber may be heated to between about 50° C. and about 800° C., and the operating pressure may be between about 7.5×10⁻² Torr and about 4 Torr (about 1 Pa to about 5000 Pa).

As a result of ALD process and surface reactions, a single atomic layer of the surface coating material is bound to the electrode surface, thereby providing a monoatomic coating. With sequential or alternating reactions, composite layers may be formed. Furthermore, additional atomic monolayers may be grown over the monoatomic layer, thereby forming a surface coating having greater thicknesses. The ALD process is illustrative of one technique for forming aluminum oxide (TiO₂) coatings on a silicon-based electrode material, but the process may also be used to form other coatings as well, by way of non-limiting example. For example, other oxide-based or carbon-based coatings may be formed on the silicon-based electrode materials via an ALD process. Moreover, various other coatings can be easily obtained by using different precursors and deposition processes.

In certain other alternative variations, an oxide-based surface coating can be synthesized on the electrode material (e.g., material comprising silicon) by wet chemistry or sol gel processes, physical vapor deposition (PVD), chemical vapor deposition (CVD), chemical vapor infiltration, and other known conventional processes to apply such coatings to solid materials. For example, in a PVD process, such as magnetron sputtering, aluminum metal can be used as target, with a gas comprising argon and oxygen (Ar:O₂) used to sputter and deposit a TiO₂ coating on the pre-fabricated graphite electrode or alternatively graphite particles. In a thermal or CVD process, temperatures above 400° C. for thermal CVD and above about 200° C. can be used for plasma CVD deposition on a pre-fabricated silicon-based electrode or alternatively onto particles comprising silicon, by way of example. Thus, applying the surface coating may comprise a deposition process including one or more coating precursor species to form an oxide-based surface coating, such as TiO₂, Al₂O₃, or SnO₂, by using a process selected from the group consisting of: ALD, CVD, PVD and wet chemistry.

In certain aspects, a negative electrode may be a material, such as a mat comprising an electroactive material in the form of a plurality of fibers comprising silicon. In certain aspects, a negative electrode may comprise electroactive particles disposed in a binder. Thus, negative electrodes may comprise greater than or equal to about 50% to less than or equal to about 90% of an electroactive material (e.g., silicon particles or carbon particles having silicon coatings), optionally greater than or equal to about 5% to less than or equal to about 30% of an electrically conductive material, and a balance binder, by way of example. Suitable electroactive materials are those discussed previously above and may be the same as the electrically conductive materials, such as silicon. Binders can be used with the electroactive material and may comprise a polymeric material and extractable plasticizer suitable for forming a bound porous composite, such as halogenated hydrocarbon polymers (such as poly(vinylidene chloride) and poly((dichloro-1,4-phenylene)ethylene), fluorinated urethanes, fluorinated epoxides, fluorinated acrylics, copolymers of halogenated hydrocarbon polymers, epoxides, ethylene propylene diamine termonomer (EPDM), ethylene propylene diamine termonomer (EPDM), polyvinylidene difluoride (PVDF), hexafluoropropylene (HFP), ethylene acrylic acid copolymer (EAA), ethylene vinyl acetate copolymer (EVA), EAA/EVA copolymers, PVDF/HFP copolymers, and mixtures thereof.

In such variations, an electrode may be made by mixing the electrode active material, such as silicon-coated carbon fibers or particles, into a slurry with a polymeric binder compound, a non-aqueous solvent, optionally a plasticizer, and optionally if necessary, additional electrically conductive particles. The slurry can be mixed or agitated, and then thinly applied to a substrate via a doctor blade. The substrate can be a removable substrate or alternatively a functional substrate, such as a current collector (such as a metallic grid or mesh layer) attached to one side of the electrode film. In one variation, heat or radiation can be applied to evaporate the solvent from the electrode film, leaving a solid residue. The electrode film may be further consolidated, where heat and pressure are applied to the film to sinter and calendar it. In other variations, the film may be air-dried at moderate temperature to form self-supporting films. If the substrate is removable, then it is removed from the electrode film that is then further laminated to a current collector. With either type of substrate, it may be necessary to extract or remove the remaining plasticizer prior to incorporation into the battery cell.

In certain preferred variations, pre-fabricated electrodes comprising silicon can be directly coated via a coating formation process, such as in atomic layer deposition (ALD), or physical vapor deposition, or chemical vapor infiltration, among others. Thus, one or more exposed regions of the pre-fabricated negative electrodes comprising the silicon can be coated to minimize or prevent cracking of silicon and formation of an SEI layer on the surfaces of negative electrode materials (like silicon) when incorporated into the electrochemical cell. In other variations, a plurality of particles comprising an electroactive material, like silicon, can be coated with an oxide-based and carbon surface coating. Then, the coated particles can be used in the active material slurry to form the negative electrode, as described above.

A battery may thus be assembled in a laminated cell structure, comprising an anode layer, a cathode layer, and electrolyte/separator between the anode and cathode layers. The anode and cathode layers each comprise a current collector. A negative anode current collector may be a copper collector foil, which may be in the form of an open mesh grid or a thin film. The current collector can be connected to an external current collector tab.

For example, in certain variations, an electrode membrane, such as an anode membrane, comprises the electrode active material (e.g., graphite) dispersed in a polymeric binder matrix over a current collector. The separator can then be positioned over the negative electrode element, which is covered with a positive electrode membrane comprising a composition of a finely divided lithium insertion compound in a polymeric binder matrix. A positive current collector, such as aluminum collector foil or grid completes the assembly. Tabs of the current collector elements form respective terminals for the battery. A protective bagging material covers the cell and prevents infiltration of air and moisture. Into this bag, an electrolyte is injected into the separator (and may also be imbibed into the positive and/or negative electrodes) suitable for lithium ion transport. In certain aspects, the laminated battery is further hermetically sealed prior to use.

Thus, in certain variations, the present disclosure provides an electroactive material, which may be used in an electrochemical cell, such as a lithium ion battery. A negative electrode material may comprise silicon or be a silicon alloy, for example. In certain variations, the negative electrode material comprises graphite. The electrode material has a surface coating formed thereon, which may have a thickness of less than or equal to about 20 nm that suppresses deposition of transition metals onto the negative electrode within the electrochemical cell. In certain variations, the silicon material is contained in a pre-fabricated electrode layer and the surface coating is applied to at least one surface of the pre-fabricated electrode layer. In other variations, the surface coating is applied to a plurality of silicon-containing particles or structures, which can then subsequently be incorporated into the electrode. In certain preferred aspects, the surface coating comprises a metal oxide and carbon. The metal oxide may comprise a metal selected from a group consisting of: titanium (Ti), aluminum (Al), tin (Sn), and combinations thereof. In certain variations, the surface coating comprises carbon and titanium dioxide (TiO₂). In certain preferred aspects, the surface coating is ultrathin and may be formed in an atomic layer deposition process, by way of example.

### Example A

In a first example, a metal oxide surface film is applied to an exemplary silicon containing anode material. In this example, the metal oxide is an ultra-thin conformal coating of titania (titanium dioxide, TiO₂) deposited using atomic layer deposition (ALD). Four different thicknesses of titania films are deposited by ALD using two different substrate temperatures on a composite electrode comprising a carbon nanofiber (commercially available as CNF MAT™ a continuous nanomaterial mat comprising carbon nanofibers sold by Applied Sciences, Inc. (ASI)). A base electrode comprising CNF/Si composite layer is prepared by Applied Sciences, Inc. (ASI) with a chemical vapor deposition (CVD) method. To prepare the electrode, a first layer of about 20 nanometer scale silicon-based material is deposited on the carbon nanofibers (CNF). The CVD process involves the thermal decomposition of silane to create the amorphous silicon on the surfaces of the CNFs.

Atomic Layer Deposition (ALD) uses two precursors to produce alternate chemical reactions on the substrate, resulting in unique self-limiting film growth with excellent conformity and accurate thickness control. The substrate is the CNF/Si composite paper mat in 0.5 inch diameter disc. Ultra-thin, conformal TiO₂ films are deposited in a P400A ALD reactor (Beneq®). The precursors used are TiCl₄ (commercially available from Fluka™, purity of ≧99.0%) and H₂O (commercially available from Sigma-Aldrich, HPLC grade). They are sequentially introduced in the gas phase into the reactor using ultra high purity N₂ as a carrier gas. The subsequent reaction builds up successive monolayers of TiO₂ film on the substrate. The films are deposited at different substrate temperatures (as detailed in Table 1 below) with gas pressures of 1 torr.

The deposition procedure includes repeated sequential ALD cycles until the desired thickness is achieved. Each ALD cycle includes the H₂O pulse, followed by purge time, the TiCl₄ pulse, and a second purge. Nitrogen purges are required to flush the unreacted gases and gaseous reaction products. A monolayer of solid TiO₂ is deposited on the surface of the substrate. The flow rate of the carrier gas is 2 SLM.

Each time in the experiment, a Si witness wafer sample is put together with the sample into the ALD reactor chamber. These witness coupons are used for EPMA measurements of the TiO₂ film thicknesses.

The simplified, sequential, self-limiting reaction is listed below, which provides repeatable TiO₂ films with atomic thickness control:

TiCl_{4(g)}+2H₂O_{(g)}→TiO₂₍ₛ₎+4HCl_{(g)}.

The bare (uncoated) CNF/Si composite electrode and TiO₂-coated electrodes are characterized by transmission electron microscopy (TEM). One quarter of each sample is placed in approximately 0.5 ml of methanol and ultrasonically dispersed for ten minutes. Drops from the dispersions are placed on individual lacey carbon TEM grids. The prepared specimens are examined in a JEOL 2100F, Cs-aberration-corrected TEM, operating at 200 kV. The samples are examined in both conventional TEM mode and scanning/TEM (S/TEM) mode using a high angle annular dark field detector (HAADF), mid-angle annular dark field detector (MAADF) and a secondary electron detector. Electron diffraction measurements are also performed in the TEM in order to determine the structure of the TiO₂.

Titanium oxide coating thicknesses are analyzed with a Cameca Instruments, Inc. (Madison, Wis., USA) model SX100 electron probe microanalyzer (EPMA). Analyses are done at 15 keV and 20 nA electron beam conditions. Ti and O X-ray intensities are converted to mass thicknesses with the thin film program GMRFILM. The φ(ρz) model used in the thin film program is the Pouchou and Pichoir (PAP) Scanning (1990) model. Typical accuracies of thin film analyses are estimated to be approximately ±10% relative. Mass thicknesses are converted to linear thicknesses using an assumed density of 4 gm./cm³. The actual film densities may be different. The oxygen contributions to mass thicknesses are calculated according to standard oxidation states of +4 for Ti and −2 for oxygen rather than from x-ray intensities. The actual oxygen x-ray intensities for all samples are consistent with the stoichiometry of TiO₂.

Table 1 below shows details regarding TiO₂ thin conformal films created by Atomic Layer Depositions at different conditions and ALD cycles.

TABLE 1

| Example | 1 | 2 | 3 | 4 | 5 |
|---|---|---|---|---|---|
| TiO₂ coating | 7 | 23 | 7.5 | 2.7 | 4 |
| thickness | | | | | |
| (nm) | | | | | |
| ALD cycle | 180 | 540 | 180 | 100 | 100 |
| numbers | | | | | |
| Substrate | 275° C. | 150° C. | 150° C. | 150° C. | 275° C. |
| temperature | | | | | |
| TiO₂ film | Anatase | Amor- | Amor- | Amor- | Anatase |
| structure | | phous | phous | phous | |

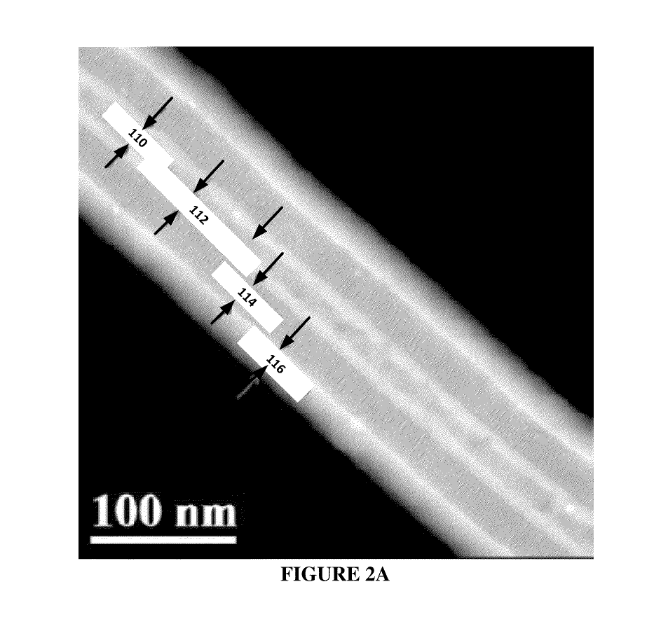

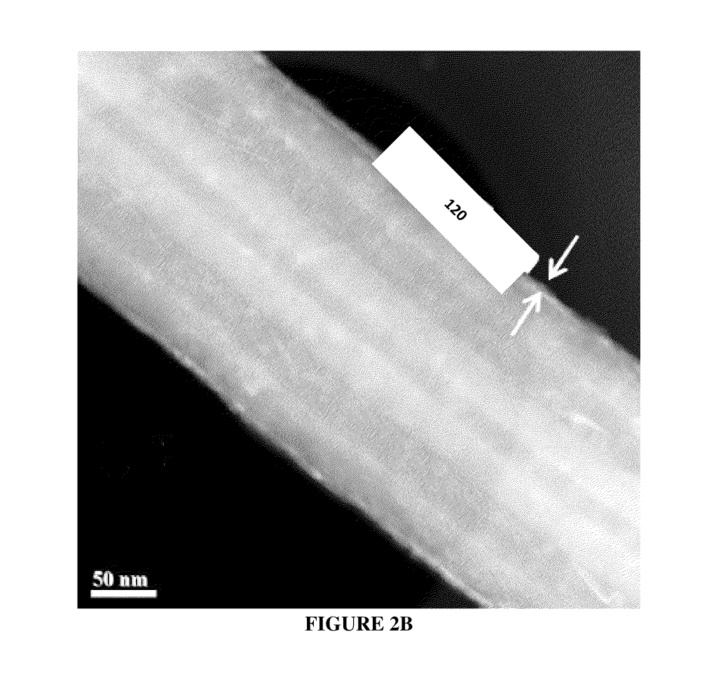

FIGS. 2A and 2B are scanning/TEM (S/TEM) micrographs. FIG. 2A shows a carbon nanofiber having a silicon anode material disposed thereon, while FIG. 2B shows a titanium oxide surface coating disposed thereon. As shown in FIG. 2A, the carbon nanofiber (114) is hollow (region shown as 110), but has a silicon coating (112) disposed on the interior surfaces (at an approximate thickness of about 10 nm) and silicon coating (116) on the exterior surfaces (at an approximate thickness of about 24 nm). FIG. 2B shows the titanium dioxide (anatase phase) coating (120) disposed on an exterior of the coated carbon fiber having a thickness of about 7 nm.

The pristine composite electrode and electrodes (e.g., either TiO₂-coated electrodes or control electrodes) are tested in coin cells (2032) having Li metal as the counter electrode. Celgard® monolayer polypropylene separators are soaked in the electrolyte solution, which included 1M LiPF₆ dissolved in ethylene carbonate-diethyl carbonate (1:2 in volume, Novolyte®). The prepared electrode composites are tested using a Maccor® battery cycler system.

The control (bare) CNF/Si anode material has a first discharge capacity around 1500 mAh/g. After 50 cycles, a bare electrode has 13% of capacity retention. Although capacity fading is still significant for the composite electrode, capacity retention can be improved by use of an ultra-thin surface coating layer comprising metal oxide (e.g., TiO₂) alone.

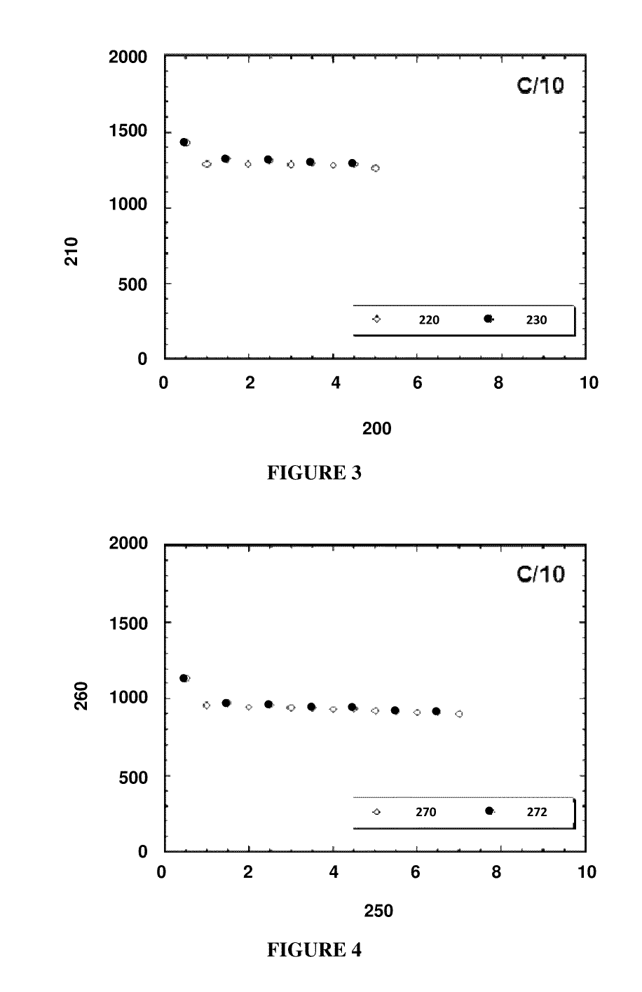

The charging and discharging profiles of the electrochemical performance of Example 1 (deposited at substrate temperature of 275° C. at 180 ALD cycles) is shown in FIG. 3. In FIG. 3, y-axis capacity (210) is in mAh/g units, while cycle number is shown on the x-axis (200). The TiO₂ is crystallized in an anatase form and has a thickness of about 7 nm. A charge rate of C/10 is used and five cycles are tested. Charge capacity (220) and discharge capacity (222) are shown. The first discharge capacity is 1426 mAh/g. The first charge capacity is 1288 mAh/g. The Coulombic efficiency is thus 90.32%. After further testing, the capacity retention for 24 cycles is about 62%.

The charging and discharging profiles of the electrochemical performance of Example 2 (deposited at substrate temperature of 150° C. at 540 ALD cycles) is shown in FIG. 4. In FIG. 4, y-axis capacity (260) is in mAh/g units, while cycle number is shown on the x-axis (250). Charge capacity (270) and discharge capacity (272) are shown.

The test battery is the same as described above and a charge rate of C/10 with five cycles is tested. The first discharge capacity is 1133 mAh/g. The first charge capacity is 957 mAh/g. The Coulombic efficiency for Example 2 is 84.47%. In comparing the electrochemical performance between Examples 1 and 2, a higher specific capacity and a better Coulombic efficiency is obtained with the TiO₂ coating in Example 1 (where the substrate temperature is 275° C. and the TiO₂ coating is crystallized) than in Example 2 (where the substrate temperature is 150° C. and the applied TiO₂ coating is amorphous).

In certain examples, an ultra-thin TiO₂-coated electrode shows about 60% capacity retention after 25 cycles of lithium insertion and deinsertion (intercalation and deintercalation). The results generally indicate that thin conformal TiO₂ coatings deposited by ALD serve to improve the electrochemical performance of Si-coated carbon nanofibers in terms of capacity retention, although it would be desirable to achieve even further gains in capacity retention for commercial practicability.

### Example B

In a second example, a carbon material is applied to an exemplary silicon containing anode material and compared to other samples. The substrate is an anode material comprising the carbon nanofiber (commercially available as CNF MAT™ a continuous nanomaterial mat comprising carbon nanofibers sold by Applied Sciences, Inc. (ASI)) having a silicon surface coating applied thereon. To prepare the electrode, a first layer of about 20 nanometer scale silicon-based material is deposited on the carbon nanofibers (CNF), and then a second thin layer of carbon is deposited over it. The CVD process involves the thermal decomposition of silane to create the amorphous silicon on the surfaces of the CNFs. The thin layer of carbon is deposited onto the surface of the CNF/Si by thermal decomposition of hydrocarbon compounds. The second layer of carbon is so thin that it could not be detected in TEM measurements. The “as-prepared” composite includes amorphous silicon and graphitic carbon having nanometer-scale thickness.

Comparative electrochemical performance is provided in Table 2. A Control of a bare CNF/Si anode, Example 1 from the experiment in Example A above (having a anatase crystal TiO₂ coating deposited at substrate temperature of 275° C. at 180 ALD cycles). Example 6 is a carbon-coated CNF/Si electrode (with no TiO₂ coating) prepared by electron beam evaporation, which has a thickness of about 60 nm. Example 7 is a carbon coated CNF/Si electrode (with no TiO₂ coating) prepared by electron beam evaporation, which has a thickness of about 25 nm. Example 8 is a carbon coated CNF/Si electrode (with no TiO₂ coating) prepared by electron beam evaporation, which has a thickness of about 10 nm. The various electrodes are tested in a battery like that described above in the context of Example A.

TABLE 2

| | Example | | | | |
|---|---|---|---|---|---|
| | | 1 | 6 | 7 | 8 |
| | Control | TiO₂ | Carbon | Carbon | Carbon |
| | Bare | Coated | Coated | Coated | Coated |
| | CNF/Si | CNF/Si | CNF/Si | CNF/Si | CNF/Si |
| First cycle | 93% | 90% | 89% | 89% | 89% |
| Coulombic | | | | | |
| efficiency | | | | | |
| First | 1456 | 1426 | 1077 | 1076 | 1015 |
| discharge | | | | | |
| capacity | | | | | |
| (mAh/g) | | | | | |
| First charge | 1352 | 1288 | 963 | 957 | 904 |
| capacity | | | | | |
| (mAh/g) | | | | | |
| Capacity | 24th cycle | 24th cycle | 24th cycle | 24th cycle | 24th cycle |
| retention | 39% | 62% | 67% | 76% | 60% |

In these examples, the carbon coated electrode electrochemical performance is the same as tested in coin cells with a C/10 rate. The carbon coated electrode capacity retention is at least about 60% capacity retention after 24 cycles of lithium ion insertion and deinsertion.

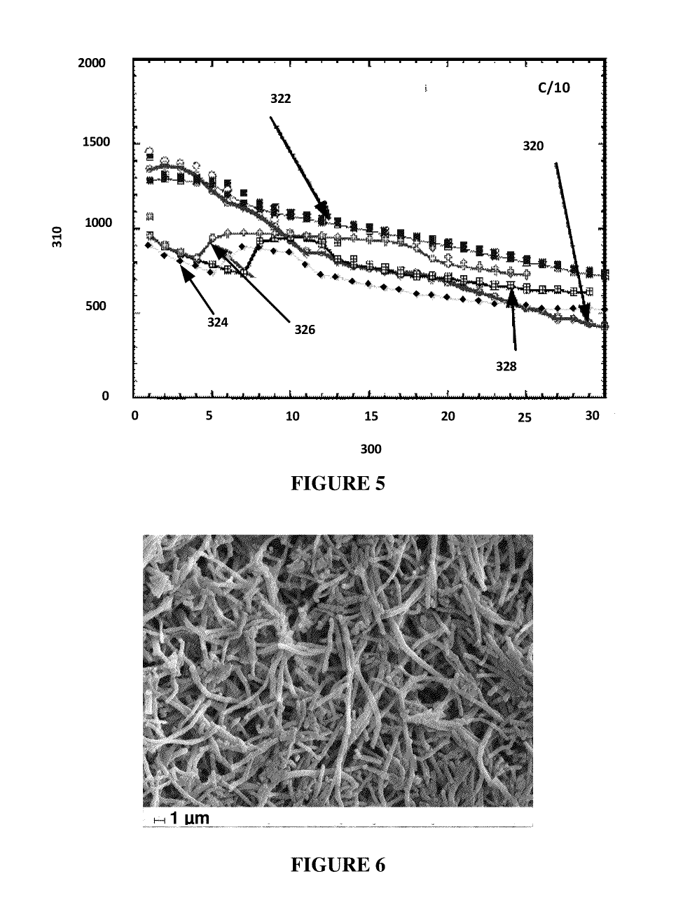

In FIG. 5, y-axis capacity (310) is in mAh/g units, while cycle number is shown on the x-axis (300). Control 1 is shown as 320, Example 1 is shown as 322, Example 6 is 328, Example 7 is 326 and Example 8 is 324. FIG. 5 shows an optimum coating for TiO₂ (having a thickness of about 7 nm—Example 1) as compared to performance of a bare electrode (Control) or those with carbon coatings at different thicknesses (Example 8 with 10 nm, Example 7 with 25 nm, or Example 6 with 60 nm). The results generally indicate that carbon coatings on Si/CNF electrodes also serve to improve the electrochemical performance of Si-coated carbon nanofibers in terms of capacity retention as compared to the Control (like TiO₂ coatings), although it would still be desirable to achieve even further gains in capacity retention for commercial practicability.

### Example C

In a third experiment, surface coatings in accordance with certain aspects of the present disclosure are prepared that comprise both carbon and metal oxide (e.g., TiO₂) material is applied to an exemplary silicon containing anode material. As in Example B, the electrode is prepared by applying a first layer of about 20 nanometer scale silicon-based material on the carbon nanofibers (CNF). Then, a second thin layer of carbon is deposited over it. The CVD process involves the thermal decomposition of silane to create the amorphous silicon on the surfaces of the CNFs. The thin layer of carbon is deposited as a porous layer onto the surface of the CNF/Si by thermal decomposition of hydrocarbon compounds. Next, an ultra-thin, conformal TiO₂ film is deposited in a P400A ALD reactor (Beneq®). The precursors are TiCl₄ (Fluka, ≧99.0%) and H₂O (Sigma-Aldrich, HPLC grade). They are sequentially introduced in the gas phase into the reactor using ultra high purity N₂ as a carrier gas. The subsequent reaction builds up successive monolayers of TiO₂ film on the substrate. The films are deposited at a substrate temperature of about 150° C. with gas pressures of 1 torr. In this manner, the ultrathin conformal TiO₂ layer deposits in the pores of the CVD carbon layer to form a nanocomposite coating having an overall thickness of about 32 nm. A s/TEM image is shown in FIG. 6 of a nanomat electrode material (having a silicon coating) with a surface coating of carbon and TiO₂ in accordance with certain aspects of the present technology.

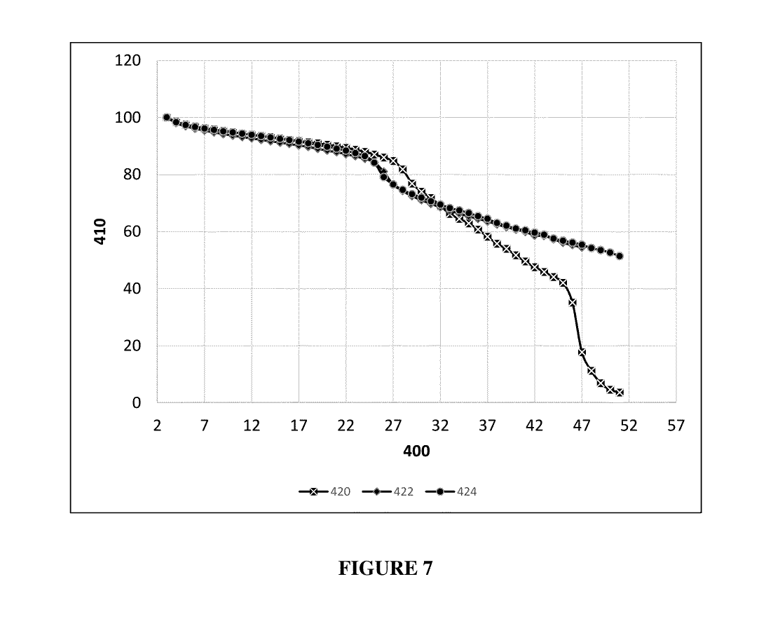

Samples are made for purposes of comparison. Examples 9-11 each have the same nanocomposite coating of carbon and titanium dioxide (TiO₂) on a CNF/Si electrode prepared as described above. These various electrodes (Examples 9-11) are tested in a battery with charging conditions like that described above in the context of Example A. A charge rate of C/10 is used and 45-50 cycles are tested. Electrochemical performance is shown in Table 3 below and in FIG. 7. In FIG. 7, y-axis is normalized discharge capacity (410), while cycle number is shown on the x-axis (400). Example 9 is 420, Example 10 is 422, and Example 11 is 424 in FIG. 7.

TABLE 3

| Example | 9 | 10 | 11 |
|---|---|---|---|
| First Cycle | 88% | 87% | 87% |
| Coulombic | | | |
| Efficiency | | | |
| First Discharge | 1154 | 1213 | 1061 |
| Capacity | | | |
| (mAh/g) | | | |
| First Charge | 1012 | 1057 | 928 |
| Capacity | | | |
| (mAh/g) | | | |
| Capacity | 90% | 89% | 90% |
| Retention | | | |
| 25 cycles | | | |
| Capacity | 35% | 55% | 56% |
| Retention | | | |
| 45 cycles | | | |

As such, these examples show that an anode materials in the form of a nano-mat with a silicon-coated carbon nanofiber having conformal coatings in the form of a nanocomposite comprising carbon and titanium oxide are capable of retaining 90% of charge capacity over at least about 25 cycles of lithium insertion and deinsertion. Moreover, such coatings can be used on any anode material comprising silicon to improve performance and charge capacity retention.

While not limiting the present teachings to any particular theory, it is hypothesized that capacity retention improvement for a silicon-containing electrode is provided at least in part by the thin TiO₂ layer deposited within the conductive carbon layer on the surface. The nanocomposite coating is believed to serve as an artificial SEI and a constraining layer (e.g., an elastic layer), which can moderate mechanical degradation from volume expansion of Si during lithium ion cycling. Moreover, use of the nanocomposite surface coatings in accordance with certain aspects of the present teachings provides capability for practical and commercial use of a silicon containing anode material in that charge capacity retention is vastly improved over conventional materials. In certain aspects, a Coulombic capacity loss of such a coated silicon-based anode material is desirably less than or equal to about 10% after 25 cycles of lithium ion intercalation and deintercalation.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode for an electrochemical cell comprising:
a coating formed on one or more surface regions of an electrode comprising silicon, wherein the coating comprises carbon and a metal oxide comprising a metal selected from a group consisting of: titanium (Ti), aluminum (Al), tin (Sn), and combinations thereof.

2. The electrode of claim 1, wherein the metal oxide is selected from a group consisting of: titanium oxide, aluminum oxide, tin oxide, and combinations thereof.

3. The electrode of claim 1, wherein the metal oxide comprises titanium dioxide (TiO₂).

4. The electrode of claim 1, wherein a thickness of the coating is less than or equal to about 60 nm.

5. The electrode of claim 1, wherein the coating comprises a porous carbon layer deposited over the one or more surface regions of the electrode and the metal oxide deposited over the porous carbon layer.

6. The electrode of claim 5, wherein a thickness of the porous carbon layer is less than or equal to about 55 nm and a thickness of the metal oxide is less than or equal to about 5 nm.

7. The electrode of claim 1, wherein the electrode comprises a fiber coated with silicon, wherein the fiber is selected from a group consisting of: carbon fibers, alumina (Al₂O₃) fibers, titanium oxide (TiO₂) fibers, and combinations thereof.

8. The electrode of claim 1, wherein the electrode comprises a carbon fiber coated with silicon.

9. A lithium ion electrochemical cell comprising:
a negative electrode comprising silicon and having a surface coating formed on one or more surface regions thereof, wherein the surface coating comprises carbon and a metal oxide comprising a metal selected from a group consisting of: titanium (Ti), aluminum (Al), tin (Sn), and combinations thereof;
a positive electrode comprising a positive lithium-based electroactive material;
a separator; and
an electrolyte; wherein the surface coating on the negative electrode provides a Coulombic capacity loss of less than or equal to about 10% after 25 cycles of lithium ion intercalation and deintercalation in the negative electrode of the lithium ion electrochemical cell.

10. The lithium ion electrochemical cell of claim 9, wherein the metal oxide is selected from a group consisting of: titanium oxide, aluminum oxide, tin oxide, and combinations thereof.

11. The lithium ion electrochemical cell of claim 9, wherein the metal oxide comprises titanium dioxide (TiO₂).

12. The lithium ion electrochemical cell of claim 9, wherein a thickness of the coating is less than or equal to about 60 nm.

13. The lithium ion electrochemical cell of claim 9, wherein the surface coating comprises a porous carbon layer deposited over the one or more surface regions of the negative electrode and the metal oxide deposited over the porous carbon layer.

14. The lithium ion electrochemical cell of claim 9, wherein the negative electrode comprises a fiber coated with silicon, wherein the fiber is selected from a group consisting of: carbon fibers, alumina (Al₂O₃) fibers, titanium oxide (TiO₂) fibers, and combinations thereof.

15. The lithium ion electrochemical cell of claim 9, wherein the negative electrode comprises a carbon fiber coated with silicon.

16. A method of making a negative electrode for an electrochemical cell, the method comprising:
applying a surface coating comprising carbon and a metal oxide comprising a metal selected from a group consisting of: titanium (Ti), aluminum (Al), tin (Sn), and combinations thereof to one or more surface regions of an electrode material comprising silicon, wherein the applied surface coating has a thickness of less than or equal to about 60 nm.

17. The method of claim 16, wherein the applying process is selected from a group consisting of: atomic layer deposition (ALD), physical vapor deposition (PVD), chemical vapor deposition (CVD), chemical vapor infiltration, wet chemistry, and combinations thereof.

18. The method of claim 16, wherein the applying comprises two distinct steps, wherein first carbon is applied to the one or more surface regions of the electrode material and second the metal oxide is applied over the carbon.

19. The method of claim 16, wherein the applying comprises concurrently applying the carbon and the metal oxide to the one or more surface regions of the electrode material.

20. The method of claim 16, wherein the applying process is atomic layer deposition (ALD) that uses a precursor of titanium tetrachloride (TiCl₄) and water to form a titanium dioxide (TiO₂) coating on the electrode material.

21. The method of claim 16, wherein the electrode material is contained in a pre-fabricated electrode layer and the surface coating is applied to at least one surface of the pre-fabricated electrode layer.

22. The method of claim 16, wherein the electrode material comprises a plurality of particles, so that the surface coating is applied to the plurality of particles that subsequently form the negative electrode.
